(19) United States
(12) Patent Application Publication
(10) Pub. No.: US 2025/0033454 A1
(43) Pub. Date: Jan. 30, 2025

(54) VEHICLE ASSEMBLY AND BODY PORTION THEREFOR

(71) Applicant: JAGUAR LAND ROVER LIMITED, Whitley (GB)

(72) Inventors: Niall SHIMMIN, Coventry (GB); Mickael VERNET, Coventry (GB); Keith DISTIN, Coventry (GB)

(21) Appl. No.: 18/361,617

(22) Filed: Jul. 28, 2023

(51) Int. Cl. B60K 1/04; B62D 21/15

(52) U.S. Cl. CPC B60K 1/04; B62D 21/15; B60K 2001/0438

(57) ABSTRACT

Aspects of the disclosure relate to a vehicle assembly and a body portion for a vehicle assembly. The vehicle assembly has a transmission, a body portion including a drivetrain tunnel and a battery pack. The vehicle assembly also includes a protrusion, which extends into the drivetrain tunnel disposed intermediate the transmission and the battery pack. The protrusion is spaced apart from the transmission such that in a crash event a movement of the transmission relative to the drivetrain tunnel and in a direction toward the protrusion is uninhibited by the protrusion for a distance beyond which the relative movement is decelerated by the protrusion.

### TECHNICAL FIELD

The present disclosure relates to a vehicle assembly and a body portion therefor. Aspects of the invention relate to a vehicle assembly, to a body portion for a vehicle assembly, and to a vehicle

### BACKGROUND

It is known to provide physical protection to an electric vehicle's (EV) battery pack. Battery packs are typically housed within a dedicated enclosure or compartment that is designed to be rigid, impact-resistant and fire-resistant. This helps safeguard the battery pack from external forces, such as crash events or road debris. Also, impact-absorbing materials and structures around the battery pack may be incorporated in a vehicle's design to provide further protection. This can include using energy-absorbing materials or designing the surrounding frame and body structure to minimise the impact on the battery pack in the event of a collision.

It is desirable to protect an EV's battery pack from damage, particularly that arising from significant collision or impact of the vehicle. Such protection may, in certain circumstances, be afforded by means that are not onerous to incorporate into existing or conventional vehicle designs, allowing manufacturers to leverage their existing production infrastructure, supply chains and manufacturing processes.

It is an aim of the present invention to address one or more of the disadvantages associated with the prior art.

### SUMMARY OF THE INVENTION

Aspects and embodiments of the invention provide a vehicle assembly, a body portion for a vehicle assembly, and a vehicle as claimed in the appended claims.

According to an aspect of the present invention there is provided a vehicle assembly comprising: a transmission; a body portion; and a battery pack. The body portion may comprise a drivetrain tunnel. The vehicle assembly may comprise a protrusion extending into the drivetrain tunnel. The protrusion may be disposed intermediate the transmission and the battery pack. The protrusion may be spaced apart from the transmission. In a crash event a movement of the transmission relative to the drivetrain tunnel and in a direction toward the protrusion may be uninhibited by the protrusion for a distance beyond which the relative movement is decelerated by the protrusion.

According to another aspect of the present invention there is provided a vehicle assembly comprising: a transmission; a body portion comprising a drivetrain tunnel; a battery pack; and a protrusion extending into the drivetrain tunnel disposed intermediate the transmission and the battery pack and spaced apart from the transmission such that in a crash event a movement of the transmission relative to the drivetrain tunnel and in a direction toward the protrusion is uninhibited by the protrusion for a distance beyond which the relative movement is decelerated by the protrusion.

The inventors recognised that some movement of the transmission may be desirable, as part of the impact-absorbing design of a vehicle, but that such movement could result in the transmission, and/or a connected component of the drivetrain, moving through the tunnel in which the drivetrain is typically housed to strike the battery pack of an EV, causing damage thereto. The above arrangement is intended to control or limit the extent of rearward movement of the transmission, and thereby provide physical protection to an EV's battery pack, in particular in the event of a significant collision or impact of the vehicle.

In certain embodiments, the protrusion may form a reinforcement, for example a reinforcement providing stiffness to the drivetrain tunnel.

In certain embodiments, the protrusion may comprise a channel section having a web and a plurality of flanges. Each of the plurality of flanges may be connected to and spaced apart from one another by the web.

In certain embodiments, edges of the flanges furthest from the web may attach the channel to a side wall of the drivetrain tunnel thereby attaching the protrusion to the drivetrain tunnel.

In certain embodiments, the drivetrain tunnel may comprise a pair of spaced apart side walls. The pair of spaced apart side walls may be connected to one another by a further wall. The protrusion may extend across the drivetrain tunnel from one of the spaced apart side walls to the other. The protrusion may be connected to each of the spaced apart side walls and the further wall.

Advantageously, the protrusion is not onerous to incorporate into existing or conventional vehicle designs, thereby allowing manufacturers to leverage their existing production infrastructure, supply chains and manufacturing processes.

In certain embodiments, the distance may be less than a further distance at which the relative movement would otherwise be decelerated by the battery pack.

In certain embodiments, the transmission may be housed in the drivetrain tunnel. Additionally or alternatively, the transmission may be moveable through the drivetrain tunnel.

In certain embodiments, the vehicle assembly may comprise a drivetrain component. The drivetrain component may be connected to the transmission. The relative movement may be decelerated by the protrusion contacting the drivetrain component. In examples, the drivetrain component may be a transfer box.

According to another aspect of the present invention there is provided a body portion, for example a body portion for a vehicle assembly. The body portion may comprise a drivetrain tunnel and a protrusion extending into the drivetrain tunnel. A drivetrain component may be receivable along a length of the drivetrain tunnel. The protrusion may extend into the drivetrain tunnel for in a crash event decelerating a movement of the drivetrain component through the drivetrain tunnel beyond a distance along the length of the tunnel.

According to a further aspect of the present invention there is provided a body portion for a vehicle assembly, the body portion comprising: a drivetrain tunnel through which a drivetrain component is receivable along a length thereof; and a protrusion extending into the drivetrain tunnel for in a crash event decelerating a movement of the drivetrain component through the drivetrain tunnel beyond a distance along the length of the tunnel.

In certain embodiments, the protrusion may form a reinforcement, for example a reinforcement providing stiffness to the drivetrain tunnel.

In certain embodiments, the protrusion may comprise a channel section having a web and flanges, for example a plurality of flanges. The flanges may be connected to and spaced apart from one another by the web.

In certain embodiments, edges of the flanges furthest from the web may attach the channel to a side wall of the drivetrain tunnel. The flanges may thus attach the protrusion to the drivetrain tunnel.

In certain embodiments, the drivetrain tunnel may comprise a pair of spaced apart side walls. The pair of spaced apart side walls may be connected to one another by a further wall. The protrusion may extend across the drivetrain tunnel from one of the spaced apart side walls to the other.

In certain embodiments, the protrusion may be connected to each of the spaced apart side walls and the further wall.

In certain embodiments, the drivetrain component may be a transmission. The drivetrain tunnel may be a transmission tunnel.

The above arrangement is intended to control or limit the extent of rearward movement of the transmission, and thereby provide physical protection to an EV's battery pack, in particular in the event of a significant collision or impact of the vehicle. Advantageously, the arrangement is not onerous to incorporate into existing or conventional vehicle designs, thereby allowing manufacturers to leverage their existing production infrastructure, supply chains and manufacturing processes.

According to another aspect of the present invention there is provided a vehicle comprising a vehicle assembly according to any of the preceding aspects of the invention.

According to a further aspect of the present invention there is provided a vehicle comprising a body portion, for example a body portion for a vehicle assembly, according to any of the preceding aspects of the invention.

According to an aspect of the present invention there is provided a vehicle comprising: a drivetrain; a battery pack; and a body portion. The body portion may comprise a drivetrain tunnel. The drivetrain may be receivable along a length of the drivetrain tunnel. In a crash event a movement of the drivetrain through the drivetrain tunnel in a direction toward the battery pack may be decelerated beyond a distance along the length of the tunnel.

According to another aspect of the present invention there is provided a vehicle comprising: a drivetrain; a battery pack; and a body portion comprising a drivetrain tunnel through which the drivetrain is receivable along a length thereof, wherein in a crash event a movement of the drivetrain through the drivetrain tunnel in a direction toward the battery pack is decelerated beyond a distance along the length of the tunnel.

In certain embodiments, the distance may be less than a further distance at which the movement would otherwise be decelerated by the battery pack.

In certain embodiments, the vehicle may comprise a protrusion extending into the drivetrain tunnel. The movement may be decelerated by the protrusion.

The above arrangement is intended to control or limit the extent of rearward movement of the transmission, and thereby provide physical protection to an EV's battery pack, in particular in the event of a significant collision or impact of the vehicle. Advantageously, the arrangement is not onerous to incorporate into existing or conventional vehicle designs, thereby allowing manufacturers to leverage their existing production infrastructure, supply chains and manufacturing processes.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

One or more embodiments of the invention will now be described, by way of example only, with reference to the accompanying drawings, in which:

FIG. 1 shows a side cross section view of a vehicle including a vehicle assembly and a body portion according to embodiments of the invention;

FIG. 2 shows a lower perspective view of the vehicle of FIG. 1;

FIG. 3 shows an alternative cross section view of the vehicle of FIG. 1; and

FIG. 4 shows a partial cross section view of a body portion according to an embodiment of the invention.

### DETAILED DESCRIPTION

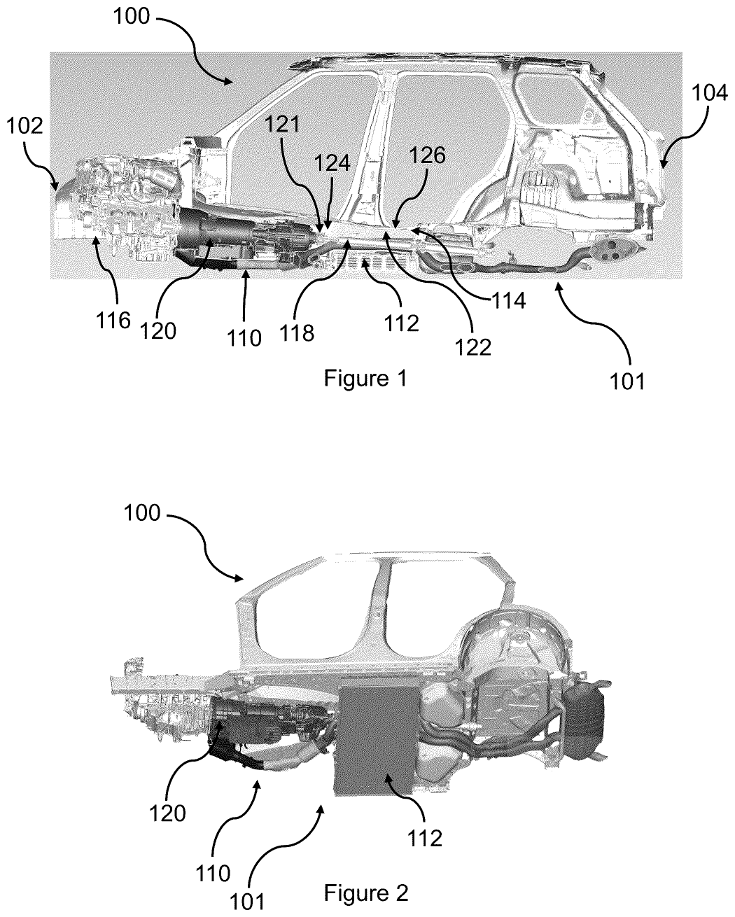

A vehicle assembly 101 and a body portion 114 in accordance with an embodiment of the present invention is described herein with reference to FIGS. 1 to 5. As shown in FIGS. 1 and 2, the vehicle assembly 101 and the body portion 114 are installed in a vehicle 100. The vehicle assembly 101 may have particular application for use in an electric vehicle (EV), for example a hybrid electric vehicle (HEV) or a plug-in hybrid electric vehicle (PHEV).

With reference to FIGS. 1 and 2, there is provided a vehicle 100. The vehicle 100 has a front end 102 and a rear end 104. The vehicle 100 also has a drivetrain 110, a battery pack 112 and a body portion 114.

The drivetrain 110 delivers power to the wheels (not shown) and includes an engine or an electric motor 116, a drive shaft 118, a transmission 120 and a transfer box 121. The drivetrain 110 includes other drivetrain components, as will be appreciated by the person skilled in the art.

The body portion 114 includes a drivetrain tunnel 122. The drivetrain tunnel 122 extends along a longitudinal axis of the vehicle 100, the longitudinal axis being defined between the front end 102 and the rear end 104 of the vehicle 100. The drivetrain tunnel 122 includes a first side wall 124, a second side wall (not shown), an upper wall 126 and a lower wall (not shown). The first and second side walls 124 are spaced apart. The drivetrain tunnel 122 houses part of the drivetrain 110. In certain embodiments, for example as shown in FIG. 1, the drivetrain tunnel 122 houses all or part of the transmission 120 and may therefore be alternatively referred to as a transmission tunnel. In other words, part of the drivetrain 110, for example the transmission 120, is receivable along a length of the drivetrain tunnel 122.

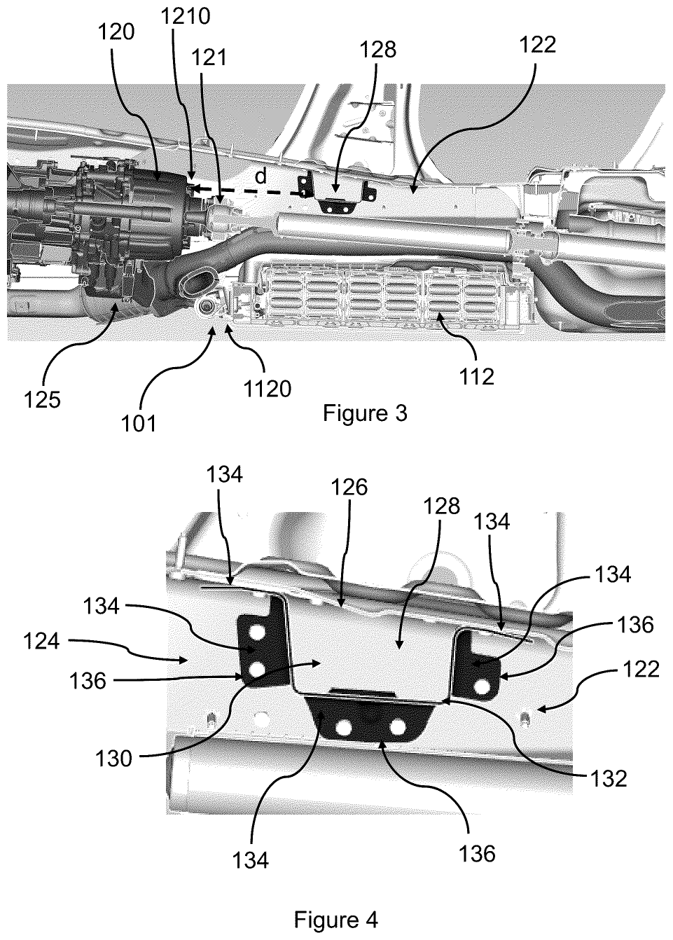

Referring now to FIGS. 3 and 4, the body portion 114 also includes a protrusion 128. The protrusion 128 is in the form of a reinforcement which provides stiffness to the drivetrain tunnel 122. The protrusion 128 extends into the drivetrain tunnel 122 and is positioned between the transmission 120 and the battery pack 112. The protrusion 128 is spaced apart from one or more components of the drivetrain 110. The protrusion 128 may, for example be spaced apart from the transmission 120. As shown in FIG. 3, the protrusion 128 is spaced apart from the transmission 120 by a distance d. The distance d is less than the distance between the lower protrusion 125 of the transmission 120 and the front face 1120 of the battery pack 112. Such that, in some embodiments of the invention, for example in a crash event, the rear face of the transmission 1210 impacts with the protrusion 128, reducing the force at which the lower protrusion 125 of the transmission 120 may clash with the front face 1120 of the battery pack 112. The reduction in force of the clash is sufficient to reduce the risk of perforation or rupturing of cells or modules within the battery pack occurring.

The protrusion 128 has a channel section 130 including a web 132 and a plurality of flanges 134. Each of the flanges 134 is connected to and spaced apart from the other flanges 134 by the web 132. Each of the flanges 134 has edges 136. The protrusion 128 is connected or attached to the drivetrain tunnel 122 using the flanges 134. In one embodiment, the edges 136 of the flanges 134 that are furthest from the web 132 are used to attached to the channel 130 of the protrusion 128 to a side wall 124 of the drivetrain tunnel 122. In another embodiment, the protrusion 128 extends across the drivetrain tunnel 122 from one of the spaced apart side walls 124 to the other side wall (not shown). The protrusion 128 may, for example, be connected to each of the spaced apart side walls 124 and a further wall, for example the upper wall 126. In either of these embodiments, the protrusion 128 may be connected to attached to the drivetrain tunnel 122 by any suitable means including, but not limited to, any suitable mechanical fastener and/or adhesive. The protrusion 128 may be, for example, attached to the drivetrain tunnel 122 by rivets, wherein the rivets extend through apertures or openings in the flanges 134.

The transmission 120, body portion 114 comprising the drivetrain tunnel 122, the battery pack 112 and the protrusion 128 together form the vehicle assembly 101.

In a crash event, movement of the transmission 120 relative to the drivetrain tunnel 122 and in a direction toward the protrusion 128 is not affected (i.e. is uninhibited) by the protrusion 128 extending into the drivetrain tunnel 122 for a distance d. If the transmission 120 travels the distance d toward the protrusion 128, the transmission 120 contacts the protrusion 128 and further, relative, movement is decelerated by the protrusion. Since the distance d is less than the distance between the transmission 120 and the battery pack 112, the protrusion 128 slows, or prevents, the transmission 120 contacting the battery pack 112 in a crash event. In other words the distance d is insufficient for the relative movement of the transmission to be decelerated by the battery pack 112.

Advantageously, the arrangement of the invention is intended to control or limit the extent of rearward movement of the transmission, and thereby provide physical protection to an EV's battery pack, in particular in the event of a significant collision or impact of the vehicle.

It will be appreciated that various changes and modifications can be made to the present invention without departing from the scope of the present application.

In some embodiments of the invention, for example, a further component e.g. a drivetrain component such as the transfer box 121, is connected to the transmission 120. In some embodiments of the invention, for example, the relative movement is decelerated by the protrusion 128 contacting another component of the drivetrain 110, e.g. the transfer box 121.

1. A vehicle assembly, comprising:
a transmission;
a body portion comprising a drivetrain tunnel;
a battery pack; and
a protrusion extending into the drivetrain tunnel disposed intermediate the transmission and the battery pack and spaced apart from the transmission such that in a crash event a movement of the transmission relative to the drivetrain tunnel and in a direction toward the protrusion is uninhibited by the protrusion for a distance beyond which the relative movement is decelerated by the protrusion.

2. The vehicle assembly according to claim 1, wherein the protrusion forms a reinforcement providing stiffness to the drivetrain tunnel.

3. The vehicle assembly according to claim 1, wherein the protrusion comprises a channel section having a web and a plurality of flanges, each of the plurality of flanges connected to and spaced apart from one another by the web.

4. The vehicle assembly according to claim 3, wherein edges of flanges furthest from the web attach the channel section to a side wall of the drivetrain tunnel thereby attaching the protrusion to the drivetrain tunnel.

5. The vehicle assembly according to claim 1, wherein the drivetrain tunnel comprises a pair of spaced apart side walls connected to one another by a further wall and the protrusion extends across the drivetrain tunnel from one of the spaced apart side walls to the other.

6. The vehicle assembly according to claim 5, wherein the protrusion is connected to each of the spaced apart side walls and the further wall.

7. The vehicle assembly according to claim 1, wherein the distance is less than a further distance at which the relative movement would otherwise be decelerated by the battery pack.

8. The vehicle assembly according to claim 1, wherein the transmission is housed in and/or moveable through the drivetrain tunnel.

9. The vehicle assembly according to claim 1, comprising a drivetrain component connected to the transmission and the relative movement is decelerated by the protrusion contacting the drivetrain component.

10. The vehicle assembly according to claim 9, wherein the drivetrain component is a transfer box.

11. A body portion for a vehicle assembly, the body portion comprising:
a drivetrain tunnel through which a drivetrain component is receivable along a length thereof; and
a protrusion extending into the drivetrain tunnel for in a crash event decelerating a movement of the drivetrain component through the drivetrain tunnel beyond a distance along the length of the drivetrain tunnel.

12. The body portion according to claim 11, wherein the protrusion forms a reinforcement providing stiffness to the drivetrain tunnel.

13. The body portion according to claim 11, wherein the protrusion comprises a channel section having a web and flanges connected to and spaced apart from one another by the web.

14. The body portion according to claim 13, wherein edges of flanges furthest from the web attach the channel section to a side wall of the drivetrain tunnel thereby attaching the protrusion to the drivetrain tunnel.

15. The body portion according to claim 11, wherein the drivetrain tunnel comprises a pair of spaced apart side walls connected to one another by a further wall and the protrusion extends across the drivetrain tunnel from one of the spaced apart side walls to the other.

16. The body portion according to claim 15, wherein the protrusion is connected to each of the spaced apart side walls and the further wall.

17. The body portion according to claim 11, wherein the drivetrain component is a transmission.

18. A vehicle, comprising:
a drivetrain;
a battery pack; and
a body portion comprising a drivetrain tunnel through which the drivetrain is receivable along a length thereof, wherein in a crash event a movement of the drivetrain through the drivetrain tunnel in a direction toward the battery pack is decelerated beyond a distance along the length of the drivetrain tunnel.

19. The vehicle according to claim 18, wherein the distance is less than a further distance at which the movement would otherwise be decelerated by the battery pack.

20. The vehicle according to claim 18, comprising a protrusion extending into the drivetrain tunnel and the movement is decelerated by the protrusion.
